(19) United States
(12) Patent Application Publication
(10) Pub. No.: US 2006/0208867 A1
(43) Pub. Date: Sep. 21, 2006

(54) Vehicle safety and warning apparatus

(76) Inventors: John E. McLoughlin, Lake Grove, NY (US); Neocles G. Athanasiades, Setauket, NY (US); Toh M. Meng, Hauppauge, NY (US)

Correspondence Address: Frank L. Hart;Attorney at Law, 8911 S. 73rd East Ave., Tulsa, OK, 74133, US

(21) Appl. No.: 11/073,493

(22) Filed: Mar. 7, 2005

(51) Int. Cl. B60Q 7/02; G08B 5/00

(52) U.S. Cl. 340/472; 340/815.4

(57) ABSTRACT

A safety and warning apparatus for attachment to a vehicle. The apparatus includes light bars that are moveable between first and second positions relative to the vehicle and control means for selectively moving the light bars and actuating lights of the light bars.

### BACKGROUND OF THE INVENTION

1. Field of the Invention

The subject invention relates to light bars connectable to a vehicle.

More particularly, the subject invention relates to safety and warning apparatus which has light bars that are selectively extendable beyond the sides of a vehicle.

2. Description of Related Art Including Information Disclosed Under 37 CFR 1.97 and 1.98

Workmen often have to perform various functions which requires them to be in close proximity or on a lane of a highway. There have been numerous instances where one of the workmen parked his truck on the shoulder of the road prior to exiting to perform some task. Upon opening the door to exit the vehicle, a car approaching from the rear hit the opening door and sometimes the workman.

In other instances the vehicle is parked on the other side of a lane next to a median for example. In those cases, a workman riding as a passenger was injured or killed by a vehicle approaching from the rear.

This invention warns oncoming vehicle to steer clear of the vehicle. In other embodiments the apparatus of the invention can be used to block traffic from one or more lanes.

Hereto fore, workmen attempted to protect themselves by setting out warning barrels or markers and by actuating the flashers of their taillights. These methods were less effective than desired since there was no indicator to warn oncoming traffic to steer clear of the edge of the workmen's vehicle.

### BRIEF SUMMARY OF THE INVENTION

A safety and warning apparatus is provided for attachment to a vehicle having an electrical power source. The safety and warning apparatus has first and second primary light bars each having lights, first and second power elements, and first and second controlling elements. The first and second primary light bars are pivotally connectable to the vehicle. Each primary light bar is pivotally moveable between first and second positions relative to the vehicle. The first and second power systems are each connected to a respective primary light bar and adapted for controllably moving the respective light bar between said first and second positions. The first controlling element is connected to the lights and connectable to the electrical power source for controllably actuating the lights of the light bars and the second controlling element is connected to the power system and adapted to move the light bars to preselected positions.

### BRIEF DESCRIPTION OF THE SEVERAL VIEWS OF THE DRAWING(S)

FIG. 1 is a rear view of a vehicle having the apparatus of this invention mounted on top of the vehicle;

FIG. 2 is a rear view of a vehicle having the apparatus of this invention mounted on the back of the vehicle;

FIG. 3 is a rear view of a portion of a vehicle having apparatus of this invention of different construction mounted on the back of the vehicle; and

FIG. 4 is a partial sectional view showing the sliding connection of a primary light bar to a secondary light bar.

### DETAILED DESCRIPTION OF THE INVENTION

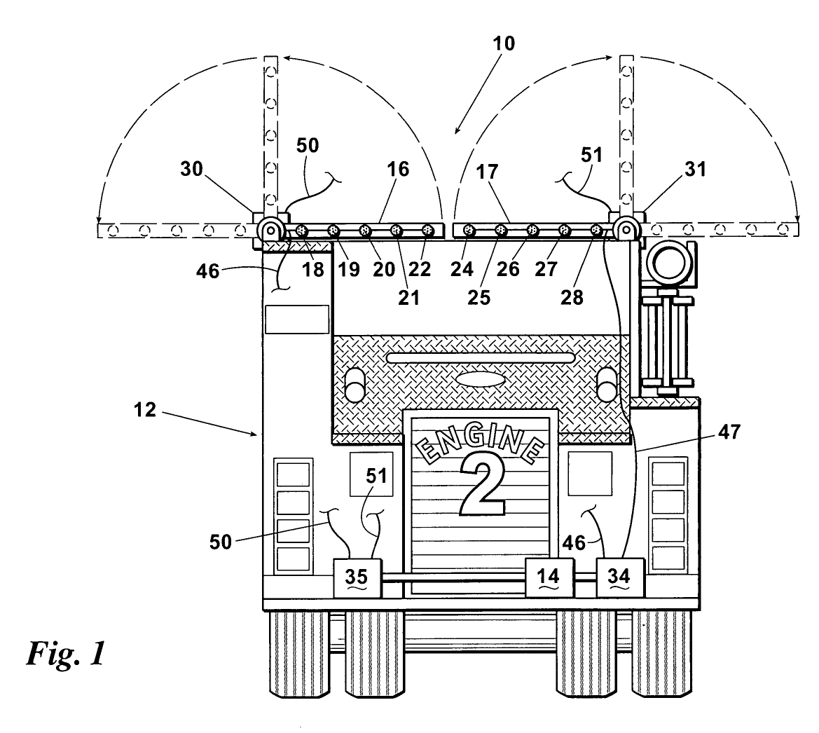

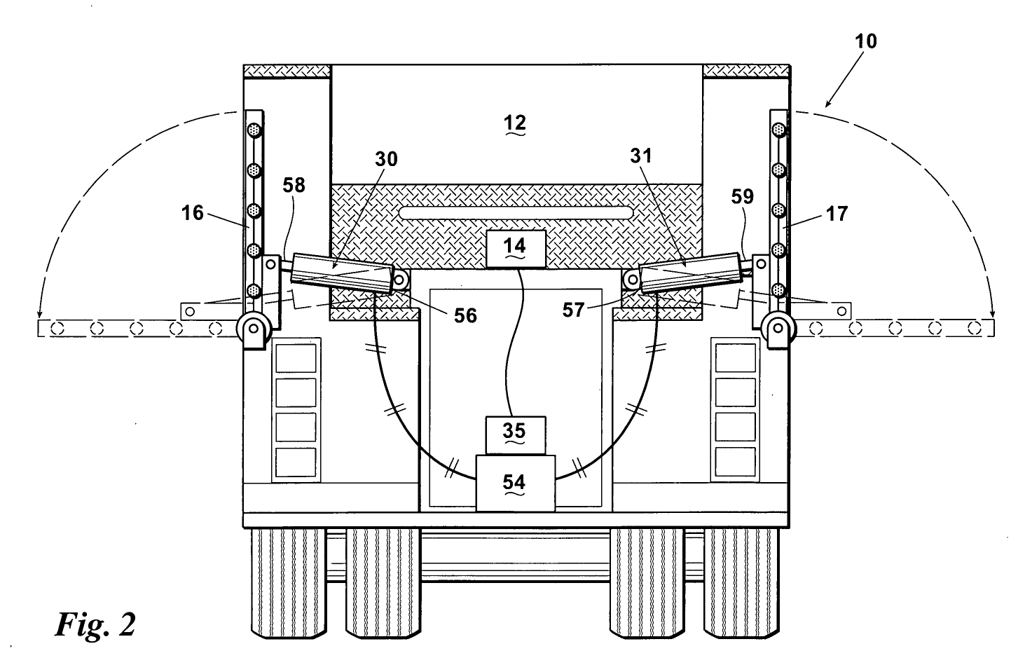

Referring to FIGS. 1 and 2, a safety and warning apparatus 10 of this invention is connected to a vehicle 12. The vehicle 12 can be a car, a truck, a pickup or any type vehicle or a most obvious use we be on a work vehicle. The vehicle, here a truck 12 for example, has an electrical power source such as, the starting battery of the truck 12. The apparatus 10 has first and second primary light bars 16,17 each having lights 18-22/24-28, first and second power elements 30,31, and first and second respective controlling elements 34,35.

The first and second primary light bars 16,17 are each pivotally connectable to the fire truck 12. Each primary light bar 16,17 is pivotally moveable between first and second positions relative to the truck or vehicle 12. As can be seen, the light bars 16, 17 are connectable to the vehicle 12 adjacent a respective side of the vehicle 12 and are pivotally moveable between a first position shown in FIGS. 1 and 2 by solid lines and a second position shown by broken lines. At the first position the primary light bars 16,17 are extending along the body of the vehicle 12 and at the second position, the primary light bars 16, 17 are extending laterally outwardly from a respective side of the vehicle 12.

Each of the primary light bars 16,17 have a length of at least 3 feet. This minimum length is required to provide a warning bar extending beyond the truck 12 a minimum distance sufficient for an individual to exit the truck 12 while maintaining the light bar between himself and oncoming traffic approaching from the rear of the truck 12. At a distance less than the stated minimum distance, an oncoming driver would not be advised of how closely he could drive next to the truck 12. By the apparatus of this invention, the truck operator can stop the vehicle, actuate a light bar to move to an extended position, actuate the light to warn approaching traffic, and then more safely open the door and exit the truck 12.

Often, highway work vehicles necessarily park on the left side of the highway. It is therefore necessary to have the apparatus of this invention mounted adjacent each side of the vehicle in order for workers to be protected when exiting the passenger side of the vehicle.

In the construction of the second controlling elements 34,35 of this invention the light bars can be responsively moved either simultaneously or, more preferably, selectively.

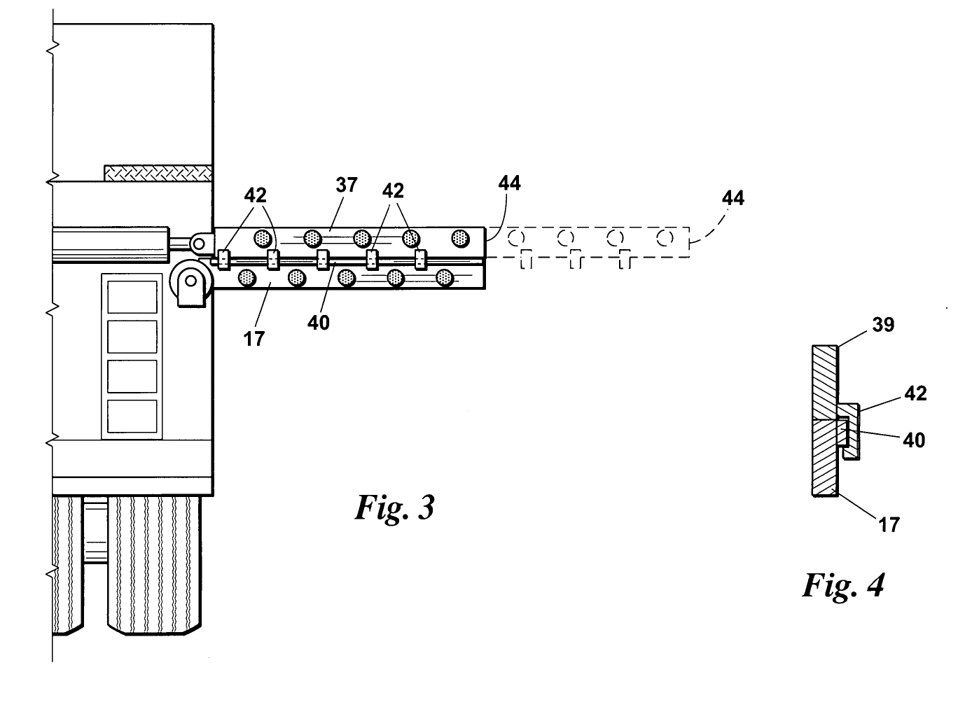

Referring to FIGS. 3 and 4, it is often necessary for highway works to block one or more lanes of traffic in order to give warning of danger. In another embodiment of the light bars 16,17 of this invention, each of the primary light bars 16, 17 has a longitudinal length and a respective secondary light bar 38/39 is connected to it. The secondary light bar 38/39 is slidably moveable along the respective longitudinal length of the respective primary light bar 16/17 and outwardly from the vehicle.

FIG. 4 shows one slidable connection of a primary light bar 17 to a respective secondary light bar 39. This example connection shows a rail 40 connected to and extending along the primary light bar 17 and the secondary light bar 39 has one or more channels 42 receiving and trapping the rail therein and providing slidable movement of the secondary light bar 39 relative to the primary light bar 17. It should be understood that each of the primary light bars 16,17 can have a secondary light bar 38, 39 and the connection between the light bars can be other than the example connection shown without departing from this invention.

In the preferred embodiment of a primary light bar 16/17 having a secondary light bar 38/39, it is desire that at the extended positions laterally outwardly from a respective side of the vehicle 12, a terminal end 44 of the secondary light bar 38/39 is positioned a preselected minimum distance of about 6 feet from the respective side of the vehicle. A distance less than about 6 feet is undesirable because such minimum distance is necessary to effectively block one lane of an average highway. It should also be understood that a vehicle equipped with the apparatus of this invention could quickly move to the cite of an accident or a disaster, extend both primary and secondary light bars and block and/or provide safety warnings to two or more lanes of traffic.

In the preferred embodiment of this invention, each light bar 16,17, 38,39 will have a plurality of lights 18,22 and 24,28 respectfully and will be connectable via lines 46,47 to the electrical power source 14 of the vehicle 12 through a first control element 34. The first controlling element 34 is for controllably actuating the lights of the light bars 16,17/38,39 and is programmable to actuate individual lights 18-22,24-28 in preferred sequence, as is known in the art.

It is preferred that the light bars 16,17, 38,39 be formed of rubber or other soft material. However, the light bars 16,17,38,39 can be formed of metal or organic plastic without departing from this invention. As a safety measure, a chain or cable can be connected to the light bars and the vehicle to prevent separation from the vehicle if impacted.

The first and second power systems 30,31 are each connected to a primary light bar 16,17 and adapted for controllably moving the respective light bars 16,17 between first and second positions as described above. In the embodiment shown in FIG. 1, the power systems 30,31 are each connected to the electrical power source 14 via controlling element 35. The power systems 30, 31 of this embodiment of the invention are gear driven electrical systems. It should be understood that the power systems 30,31 can be of other construction without departing from this invention. For example, the systems can be pneumatic systems or spring driven with pneumatic return drive.

Referring to FIG. 2, the first and second power systems 30, 321 include a pressurized fluid source 54 connected to first and second hydraulic or pneumatic cylinders, each having first and second ends 56,57, 58,59 respectively. The first ends 56,57 are connectable to the vehicle 12 and the second ends 58,59 are connected to a respective primary light bar 16,17.

In the light bar embodiment shown in FIG. 3, the secondary light bars 38,39 can be hydraulically or pneumatically moveable to the extended position. Preferably the secondary light bars 38,39 are manually moveable to their extended position.

Other aspects, objects and advantages of this invention will be come apparent from a study of the drawings, the disclosure and the appended claims.

1. A safety and warning apparatus for attachment to a vehicle having an electrical power source, comprising:
first and second primary light bars each having lights and being pivotally connectable to a vehicle, each primary light bar being pivotally moveable between first and second positions relative to the vehicle;
first and second power systems each connected to a respective primary light bar and adapted for controllably moving the respective light bar between said first and second positions; and
first and second controlling elements, said first controlling element being connected to the lights and connectable to the electrical power source for controllably actuating the lights of the light bars and said second controlling element being connected to the power systems and adapted to controllably, selectively move the respective light bars to preselected positions.

2. A safety and warning apparatus, as set forth in claim 1, wherein said first and second power system are each connected to the electrical power source and each includes an electrically driven gear system.

3. A safety and warning apparatus, as set forth in claim 1, wherein said first and second power system includes a pressurized fluid source connected to first and second hydraulic cylinders, each of said first and second hydraulic cylinders having first and second ends, said first ends being connectable to the vehicle and said second ends being connected to a respective primary light bar.

4. A safety and warning apparatus, as set forth in claim 1, wherein said first and second power system includes a pressurized fluid source connected to first and second pneumatic cylinders each having first and second ends, said first ends being connectable to the vehicle and said second ends being connected to a respective primary light bar.

5. A safety and warning apparatus, as set forth in claim 1, wherein each of the primary light bars is independently moveable between a first position at which it is extending along the body of the vehicle and a second position at which it is extending laterally outwardly from a respective side of the vehicle.

6. A safety and warning apparatus, as set forth in claim 1, wherein each of the primary light bars has a length of at least 3 feet.

7. A safety and warning apparatus, as set forth in claim 1, wherein each of the primary light bars has a longitudinal length and a secondary light bar connected thereto, said secondary light bar being slidably moveable along the respective longitudinal length of the respective primary light bar and outwardly from the vehicle.

8. A safety and warning apparatus, as set forth in claim 7, wherein the secondary light bars are each manually moveable to the extended position.

9. A safety and warning apparatus, as set forth in claim 7, wherein each of the primary and secondary light bars at the extended positions laterally outwardly from a respective side of the vehicle have a respective terminal end on the secondary light bar a preselected minimum distance of about 6 feet from the respective side of the vehicle.

10. A safety and warning apparatus, as set forth in claim 7, wherein the secondary light bars are hydraulically moveable to the extended position.

11. A safety and warning apparatus, as set forth in claim 7, wherein the secondary light bars are pneumatically moveable to the extended position.

12. A safety and warning apparatus, as set forth in claim 1, including a plurality of separate lights on each light bar and a controller connected to the electrical power means and to lights of each light bar for controlling the sequence of energizing of each light of the light bar.

13. A safety and warning apparatus, as set forth in claim 1, wherein the light bars are formed of rubber.

14. A safety and warning apparatus, as set forth in claim 1, wherein the light bars are formed of metal.

15. A safety and warning apparatus, as set forth in claim 1, wherein the light bars are formed of organic plastic.

16. A safety and warning apparatus, as set forth in claim 1, wherein the controlling element can selectively actuate the power systems.

17. A safety and warning apparatus, as set forth in claim 1, wherein the controlling element can simultaneously actuate the power systems.

18. A safety and warning apparatus, as set forth in claim 1, wherein the lights of the light bars are actuated in response to moving of the respective light bar to the extended position.
